(19) United States
(12) Patent Application Publication
(10) Pub. No.: US 2023/0218384 A1
(43) Pub. Date: Jul. 13, 2023

(54) THERMOPLASTIC VASCULAR STRUCTURES

(71) Applicant: The Government of the United States of America, as represented by the Secretary of the Navy, Arlington, VA (US)

(72) Inventors: Brandon Powell, Washington, DC (US); John Montgomery, Washington, DC (US); Bradley Segelhorst, Washington, DC (US); Christopher Ferri, Washington, DC (US); Alex Snouffer, Washington, DC (US)

(21) Appl. No.: 18/093,017

(22) Filed: Jan. 4, 2023

Related U.S. Application Data
(60) Provisional application No. 63/296,480, filed on Jan. 4, 2022.

(51) Int. Cl. A61F 2/04; A61F 2/82

(52) U.S. Cl. CPC A61F 2/04; A61F 2/82; A61F 2210/0076

(57) ABSTRACT

A thermoplastic vascular structure has a first thermoplastic sheet including at least one first recess; and a second thermoplastic sheet. The first thermoplastic sheet is attached to the second thermoplastic sheet to create a continuous branched vascular network structure. The at least one first recess creates at least one fluid channel through the continuous branched vascular network structure. The second thermoplastic sheet may have at least one second recess. The at least one first recess of the first thermoplastic sheet may align with the at least one second recess of the second thermoplastic sheet to create the at least one fluid channel through the continuous branched vascular network structure.

### CROSS REFERENCE TO RELATED APPLICATION(S)

This application claims the benefit of U.S. Provisional Patent Application No. 63/296,480 filed on Jan. 4, 2022, the contents of which, in its entirety, is herein incorporated by reference.

### GOVERNMENT INTEREST

The embodiments herein may be manufactured, used, and/or licensed by or for the United States Government without the payment of royalties thereon.

### BACKGROUND

### Technical Field

The embodiments herein generally relate to thermal control of surfaces, and more specifically to high performance thermal control of heat-dissipating components and large areas with uniform or non-uniform applied heat, in both terrestrial and aerospace applications.

### Description of the Related Art

In many high-performance systems, proper management of temperatures due to high thermal loads (both system-generated and externally applied) is critical and requires a dedicated thermal system to acquire, transport, and reject the heat. These systems are found in many military and commercial technologies, ranging from the coolant loop in a typical internal combustion-powered vehicle to the heat pipes and fan-assisted radiators found in high performance computers.

Fluid loops are used regularly in thermal management due to their unique ability to (1) efficiently absorb heat into the fluid through convection, and (2) efficiently transport heat long distances by moving the fluid mass after it has absorbed the heat. Fluid loops can operate using either a single-phase fluid or a two-phase fluid. Single phase (i.e., liquid or gas only) fluid loops are relatively inexpensive to design and manufacture but have limited performance capability. In single-phase fluid loops, the temperature of any heat source is inherently limited to be at or above the heat rejection temperature. For example, a water-cooled internal combustion engine cannot operate continuously at a temperature below that of the ambient air flowing through the radiator. Additionally, as heat is added to a single phase fluid, the temperature rises linearly with respect to the applied heat. This linear relationship between applied heat flux and temperature rise continues until the temperature has risen above the saturation temperature, at which point the fluid will begin to change phase (i.e., boil).

The phase change of fluid is particularly useful in thermal management and allows for a fluid to absorb heat while maintaining a consistent temperature. By designing a system to operate with a two-phase fluid (existing in both a liquid and a gaseous state), the heat absorbed by the fluid vaporizes additional liquid but does not change the bulk temperature of the fluid. This isothermal behavior is a significant advantage of two-phase thermal management systems. An additional benefit of a two-phase fluid system is the ability to maintain a heat-generating component at a temperature lower than that of the rejection side of the loop by using a compressor to add work to the system, thereby generating a temperature lift for rejecting the heat. A common example of this is a home air conditioning system, where the internal temperature of a home in the summer can remain below that of the ambient environment outside.

As engineers and consumers demand higher performance in smaller packages, multifunctional systems are becoming more common as components are required to serve multiple purposes to reduce size and weight. For example, several modern electric vehicles have begun to integrate the battery pack as a structural member of the vehicle, thereby saving weight by requiring separate structures to house the battery and stiffen the vehicle frame. Thermal management systems have historically been separated from other structural components, but in order to meet the demands of modern systems the two are becoming more intertwined as structural components begin to serve as components in a thermal management system. Vascular composites are described in U.S. Pat. No. 10,865,306 and U.S. Patent Application Publication No. 2013/0065042, which allows fluid channels to be embedded in a composite structure made of a reinforcing fiber and thermoset matrix material. The result is a multifunctional structure: the composite can act as a structural member in the overall system, while also allowing for heat to be acquired by a fluid flowing through the embedded channels. The U.S. Naval Research Laboratory integrated this technology with an advanced two-phase heat transfer system, resulting in two-phase vascular composites as described in U.S. Patent Application Publication No. 2020/0180245, the complete disclosure of which, in its entirety, is herein incorporated by reference. This technology allows for a large area to be maintained at a constant and even temperature throughout for a wide range of applied heat loads, even if the heat load is applied only on portions of the surface. The intent of this technology is to reduce thermal distortions of large space-based structures by preventing large thermal gradients across the surface of the structure.

While this technology is incredibly effective in solving a niche problem, there are some aspects of using two-phase vascular composites that are not ideal in all circumstances. Manufacturing vascular composite structures is a highly specialized field, requiring custom tooling, expensive manufacturing facilities, and specially trained personnel. The manufacturing process is time-consuming, relies upon expensive materials, and—like many composite structures—is subject to manufacturing defects due to human error in the process. In spacecraft engineering the trade-off between performance and cost/schedule often leans toward optimizing performance, and in such a system, two-phase vascular composite thermal management systems certainly have a role. For many aerospace and terrestrial applications, however, manufacturing cost and production time are considered more important in the system trade. Once cost, time, and maintainability play a more significant role, vascular composites may lose to lesser-performing thermal management technologies in the system-level trade. For these applications, a heat acquisition method must be developed that operates in a similar manner as vascular composites (i.e., allow for fluid flow, optionally for two-phase fluid, through embedded passages in a potentially load-bearing structure) but be less expensive, have a shorter production schedule, and be either easily serviceable or replaceable.

Thermoplastics, commonly referred to as “plastic” materials such as Polycarbonate, Polystyrene, PVC, ABS, etc., have unique properties that make them useful in nearly every industry. Thermoplastic materials differ at the molecular level from thermoset materials by the way the individual material molecules interact with one-another. Both thermoplastic and thermoset materials are comprised of individual molecules (polymers), each molecule containing repeating units (mers). Thermoplastic polymers gain their strength through entangling individual molecules, whereas thermoset polymers actually create a permanent bond between individual molecules (i.e., cross-linking). Thermoset polymers, due to the additional bond created, are generally much stronger and stiffer than thermoplastics. Since the crosslinks are permanent, the resulting thermoset structure will remain in the molded shape regardless of temperature unless the part is stressed into a deformed state. Thermoplastics, in contrast, are generally weaker and more flexible than thermosets, but also absorb more impact energy without fracturing due to the ability to detangle molecules without breaking a bond between them. The name “thermoplastic” refers to the fact that the material softens when heated, allowing it to be formed to a new shape and cooled to a zero-stress state in that shape. Specifically, thermoplastic structures are generally less expensive, more rapidly manufactured, and both easily serviceable or easily replaced when compared to thermoset structures, albeit less strong and stiff.

There are several manufacturing methods capable of producing thermoplastic components, but many are incapable of forming internal flow paths. Blow molding, for example, is highly effective in mass-producing thin-walled hollow structures such as water bottles but may not be effective for large surfaces. Rotational molding can generate internal geometries but may lack the precision in wall thickness required for large structures.

### SUMMARY

In view of the foregoing, an embodiment herein provides a thermoplastic vascular structure comprising a first thermoplastic sheet comprising at least one first recess; and a second thermoplastic sheet, wherein the first thermoplastic sheet is attached to the second thermoplastic sheet to create a continuous branched vascular network structure, and wherein the at least one first recess creates at least one fluid channel through the continuous branched vascular network structure. The thermoplastic vascular structure may comprise at least one fluid inlet connected to the at least one fluid channel; and at least one fluid outlet connected to the at least one fluid channel. The at least one fluid inlet may be connected to the at least one fluid channel at a first end of the continuous branched vascular network structure. The at least one fluid outlet may be connected to the at least one fluid channel at a second end of the continuous branched vascular network structure. The at least one fluid outlet may be connected to the at least one fluid channel at the first end of the continuous branched vascular network structure. The first thermoplastic sheet and the second thermoplastic sheet may be thermally deformable.

Another embodiment provides a thermoplastic vascular structure comprising a first thermoplastic sheet comprising at least one first recess; and a second thermoplastic sheet. The first thermoplastic sheet is attached to the second thermoplastic sheet to create a continuous branched vascular network structure. The at least one first recess creates at least one fluid channel through the continuous branched vascular network structure. The second thermoplastic sheet may comprise at least one second recess. The at least one first recess of the first thermoplastic sheet may align with the at least one second recess of the second thermoplastic sheet to create the at least one fluid channel through the continuous branched vascular network structure.

Another embodiment provides a method of forming a thermoplastic vascular structure, the method comprising providing a first thermoplastic sheet and a second thermoplastic sheet; forming at least one first recess in the first thermoplastic sheet; forming at least one second recess in the second thermoplastic sheet; aligning the at least one first recess to the at least one second recess; and attaching the first thermoplastic sheet to the second thermoplastic sheet to create a continuous branched vascular network structure, wherein attachment of the first thermoplastic sheet to the second thermoplastic sheet with an alignment of the at least one first recess to the at least one second recess creates at least one fluid channel through the continuous branched vascular network structure.

The method may comprise providing a first structure-forming mold containing at least one first recessed portion; providing a second structure-forming mold containing at least one second recessed portion; placing the first thermoplastic sheet on the first structure-forming mold, wherein the first thermoplastic sheet covers the at least one first recessed portion; and placing the second thermoplastic sheet on the second structure-forming mold, wherein the second thermoplastic sheet covers the at least one second recessed portion. The method may comprise fitting a first designated portion of the first thermoplastic sheet into the at least one first recessed portion of the first structure-forming mold such that the first designated portion of the first thermoplastic sheet contours to a shape of the at least one first recessed portion of the first structure-forming mold to create the at least one first recess in the first thermoplastic sheet; and fitting a second designated portion of the second thermoplastic sheet into the at least one second recessed portion of the second structure-forming mold such that the second designated portion of the second thermoplastic sheet contours to a shape of the at least one second recessed portion of the second structure-forming mold to create the at least one second recess in the second thermoplastic sheet.

The method may comprise aligning the first structure-forming mold containing the first thermoplastic sheet to the second structure-forming mold containing the second thermoplastic sheet; aligning the first thermoplastic sheet to the second thermoplastic sheet such that the at least one first recess in the first thermoplastic sheet aligns with the at least one second recess in the second thermoplastic sheet; and bonding the first thermoplastic sheet to the second thermoplastic sheet. The method may comprise deforming the first thermoplastic sheet and the second thermoplastic sheet by a process comprising heating the first thermoplastic sheet and the second thermoplastic sheet; and applying a vacuum process to shape the first thermoplastic sheet and the second thermoplastic sheet.

The method may comprise pressing the first thermoplastic sheet against the second thermoplastic sheet to create the continuous branched vascular network structure comprising a continuous piece of thermoplastic material, wherein an alignment of the at least one first recess with the at least one second recess creates the at least one fluid channel. The method may comprise cooling the continuous branched vascular network structure; removing the first structure-forming mold and the second structure-forming mold from the continuous branched vascular network structure; and selectively sizing the continuous branched vascular network structure. The method may comprise applying heat while performing the pressing of the first thermoplastic sheet against the second thermoplastic sheet to bond the first thermoplastic sheet to the second thermoplastic sheet.

The bonding of the first thermoplastic sheet to the second thermoplastic sheet may comprise performing a welding process utilizing a solvent, heat, or ultrasonic welding, or a combination thereof to bond the first thermoplastic sheet to the second thermoplastic sheet; although other suitable bonding processes and techniques may be utilized. The bonding of the first thermoplastic sheet to the second thermoplastic sheet may comprise applying an adhesive to the first thermoplastic sheet and the second thermoplastic sheet to bond the first thermoplastic sheet to the second thermoplastic sheet.

Another embodiment provides a thermal control system comprising a vapor-compression refrigeration cycle (VCRC) sub-system comprising at least one thermal expansion valve; at least one condenser operatively connected to the at least one thermal expansion valve; and at least one compressor operatively connected to the at least one condenser. The thermal control system further comprises a thermoplastic vascular structure operatively connected to the at least one thermal expansion valve and the at least one compressor, wherein the thermoplastic vascular structure comprises a first thermoplastic sheet comprising at least one first recess; and a second thermoplastic sheet, wherein the first thermoplastic sheet is attached to the second thermoplastic sheet to create a continuous branched vascular network structure, and wherein the at least one first recess creates at least one fluid channel through the continuous branched vascular network structure.

The thermoplastic vascular structure may comprise at least one fluid inlet connected to the at least one fluid channel; and at least one fluid outlet connected to the at least one fluid channel, wherein the at least one fluid inlet is to receive fluid from the at least one thermal expansion valve of the VCRC sub-system, wherein the at least one fluid channel of the continuous branched vascular network structure is to receive the fluid from the at least one fluid inlet and permit heat transfer of the thermoplastic vascular structure while the fluid flows through the at least one fluid channel, and wherein the at least one fluid outlet is to transmit the fluid from the thermoplastic vascular structure to the at least one compressor of the VCRC sub-system. The at least one condenser may receive the fluid from the at least one compressor and transmit the fluid to the at least one thermal expansion valve. The fluid comprises a two-phase fluid.

These and other aspects of the embodiments herein will be better appreciated and understood when considered in conjunction with the following description and the accompanying drawings. It should be understood, however, that the following descriptions, while indicating exemplary embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a perspective view schematic diagram illustrating a thermoplastic vascular structure, according to an embodiment herein;

FIG. 2A is a cross-sectional front view schematic diagram illustrating a first step in a manufacturing process of the thermoplastic vascular structure of FIG. 1, according to an embodiment herein;

FIG. 2B is a cross-sectional front view schematic diagram illustrating a second step in a manufacturing process of the thermoplastic vascular structure of FIG. 1, according to an embodiment herein;

FIG. 2C is a cross-sectional front view schematic diagram illustrating a third step in a manufacturing process of the thermoplastic vascular structure of FIG. 1, according to an embodiment herein;

FIG. 2D is a cross-sectional front view schematic diagram illustrating a fourth step in a manufacturing process of the thermoplastic vascular structure of FIG. 1, according to an embodiment herein;

FIG. 2E is a perspective view schematic diagram illustrating an example of a shape or configuration of a continuous branched vascular network structure, according to an embodiment herein;

FIG. 3A is a cross-sectional front view schematic diagram illustrating a first step in a manufacturing process of an alternative thermoplastic vascular structure, according to an embodiment herein;

FIG. 3B is a cross-sectional front view schematic diagram illustrating a second step in a manufacturing process of an alternative thermoplastic vascular structure, according to an embodiment herein;

FIG. 3C is a cross-sectional front view schematic diagram illustrating a third step in a manufacturing process of an alternative thermoplastic vascular structure, according to an embodiment herein;

FIG. 3D is a cross-sectional front view schematic diagram illustrating a fourth step in a manufacturing process of an alternative thermoplastic vascular structure, according to an embodiment herein;

FIG. 3E is a perspective view schematic diagram illustrating an example of a shape or configuration of an alternative continuous branched vascular network structure, according to an embodiment herein;

FIG. 4A is a top view schematic diagram illustrating an arrangement of a fluid inlet and fluid outlet of the thermoplastic vascular structure of FIG. 1, according to an embodiment herein;

FIG. 4B is a top view schematic diagram illustrating an arrangement of multiple fluid inlets and outlets of the thermoplastic vascular structure of FIG. 1, according to an embodiment herein;

FIG. 4C is a top view schematic diagram illustrating another arrangement of a fluid inlet and fluid outlet of the thermoplastic vascular structure of FIG. 1, according to an embodiment herein;

FIGS. 5A is a flow diagram illustrating a method of forming a thermoplastic vascular structure, according to an embodiment herein;

FIG. 5B is a flow diagram illustrating a method of using molds to align thermoplastic sheets, according to an embodiment herein;

FIG. 5C is a flow diagram illustrating a method of shaping thermoplastic sheets in molds, according to an embodiment herein;

FIG. 5D is a flow diagram illustrating a method of attaching thermoplastic sheets, according to an embodiment herein;

FIG. 5E is a flow diagram illustrating a method of deforming thermoplastic sheets, according to an embodiment herein;

FIG. 5F is a flow diagram illustrating a method of creating a continuous branched vascular network structure, according to an embodiment herein;

FIG. 5G is a flow diagram illustrating a method of shaping a continuous branched vascular network structure, according to an embodiment herein;

FIG. 5H is a flow diagram illustrating a method of pressing thermoplastic sheets together, according to an embodiment herein;

FIG. 5I is a flow diagram illustrating a first method of bonding thermoplastic sheets, according to an embodiment herein;

FIG. 5J is a flow diagram illustrating a second method of bonding, according to an embodiment herein;

FIG. 6A is a block diagram of a thermal control system, according to an embodiment herein; and

FIG. 6B is a block diagram of the thermoplastic vascular structure of the thermal control system of FIG. 6A, according to an embodiment herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

It will be understood that when an element or layer is referred to as being “on”, “connected to”, or “coupled to” another element or layer, it may be directly on, directly connected to, or directly coupled to the other element or layer, or intervening elements or layers may be present. In contrast, when an element or layer is referred to as being “directly on”, “directly connected to”, or “directly coupled to” another element or layer, there are no intervening elements or layers present. It will be understood that for the purposes of this disclosure, “at least one of X, Y, and Z” or “any of X, Y, and Z” may be construed as X only, Y only, Z only, or any combination of two or more items X, Y, and Z (e.g., XYZ, XY, XZ, YZ).

The description herein describes inventive examples to enable those skilled in the art to practice the embodiments herein and illustrate the best mode of practicing the embodiments herein. Upon reading the following description in light of the accompanying drawing figures, those skilled in the art will understand the concepts of the disclosure and will recognize applications of these concepts not particularly addressed herein.

Although the terms first, second, etc. may be used herein to describe various elements, but these elements should not be limited by these terms as such terms are only used to distinguish one element from another. For example, a first element could be termed a second element, and, similarly, a second element could be termed a first element, etc. without departing from the scope of the present disclosure. As used herein, the term “and/or” includes any and all combinations of one or more of the associated listed items.

Moreover, when an element is referred to as being “connected”, “operatively connected”, or “coupled” to another element, it can be directly connected or coupled to the other element or intervening elements may be present. Conversely, when an element is referred to as being “directly connected” or “directly coupled” to another element, there are no intervening elements present.

Furthermore, although the terms “upper”, “lower”, “bottom”, “side”, “intermediate”, “middle”, and “top”, etc. may be used herein to describe various elements, but these elements should not be limited by these terms. These terms are only used to distinguish one element from another. For example, a first element could be termed an “upper” element and, similarly, a second element could be termed an “upper” element depending on the relative orientations of these elements.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprise(s)”, “comprising”, “include(s)”, and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having meanings that are consistent with their meanings in the context of this specification and the relevant art and will not be interpreted in an idealized or overly formal sense unless expressly so defined herein.

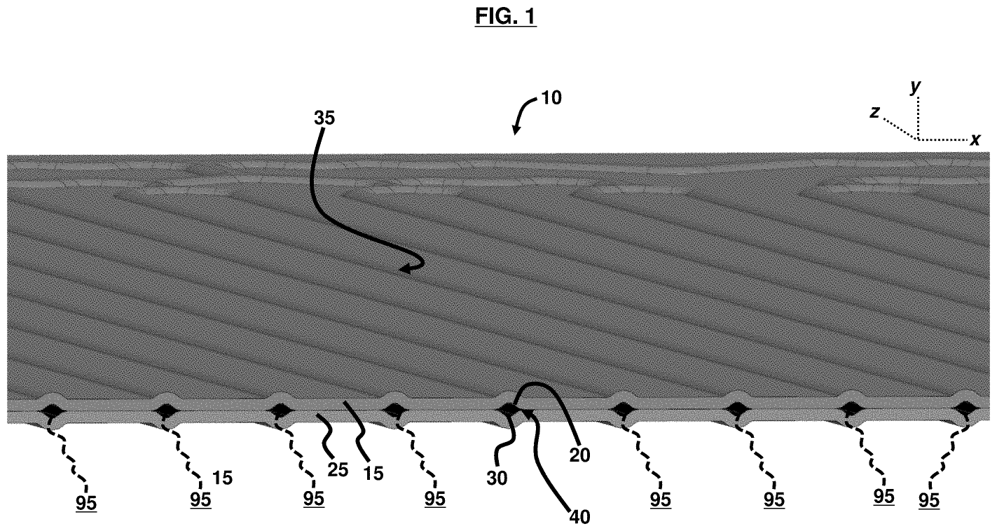

The embodiments herein provide a thin thermoplastic structure through which fluid may pass in a branched vascular-style fluid network, allowing for active thermal management of the thermoplastic structure. The structure is capable of sustaining fluid temperatures and pressures as operating conditions dictate and has a plurality of fluid inlets and outlets to permit continuous flow throughout the structure. The structure may optionally be integrated into a two-phase thermal management system for improved system capability and performance. By encapsulating a branched vascular network as described previously in a less expensive material that can be rapidly manufactured, as well as be easily serviceable or easily replaced, the embodiments herein seek to improve upon prior art by addressing each of the aforementioned shortcomings of the conventional solutions. The embodiments herein provide a new solution to large-surface thermal control, which eliminates the disadvantages of using both conventional thermal control systems as well as the aforementioned conventional solutions. Referring now to the drawings, and more particularly to FIGS. 1 through 6B, where similar reference characters denote corresponding features consistently throughout the figures, there are shown preferred embodiments. In the drawings, the size and relative sizes of components, layers, and regions, etc. may be exaggerated for clarity.

FIG. 1 is a perspective view schematic diagram illustrating a thin thermoplastic vascular structure 10 through which fluid 95 may pass in a branched vascular-style fluid network arrangement. In a single phase implementation, some examples of the fluid 95 may include water, ethylene glycol, or Polyalphaolefin (PAO). In a two-phase implementation, some examples of the fluid 95 may include ChloroFluoroCarbons (CFC) refrigerants, HydroChloroFluoroCarbons (HCFC) refrigerants, HydroFluoroCarbons (HFC) refrigerants, Water (can be used in either single or two phase), or Ammonia. However, the embodiments herein are not restricted to these particular examples for the fluid 95.

The thermoplastic vascular structure 10 comprises a first thermoplastic sheet 15 comprising at least one first recess 20, and a second thermoplastic sheet 25 comprising at least one second recess 30.

The first thermoplastic sheet 15 and the second thermoplastic sheet 25 may each comprise any suitable type of material such as, for example, Polycarbonate, Polystyrene Polyvinyl chloride (PVC), Acrylonitrile Butadiene Styrene (ABS), Low Density Polyethylene (LDPE), High Density Polyethylene (HDME), Ultra-High molecular weight polyethylene (UHMWPE), Polypropylene (PP), Polyimide, or Biaxially-oriented polyethylene terephthalate (BoPET). However, the embodiments herein are not restricted to these particular examples for the materials of the first thermoplastic sheet 15 and the second thermoplastic sheet 25, and accordingly any type of plastic material that can be thermoformed and thermowelded may be used for the first thermoplastic sheet 15 and the second thermoplastic sheet 25.

The first thermoplastic sheet 15 is attached to the second thermoplastic sheet 25 to create a continuous branched vascular network structure 35. In an example, the first thermoplastic sheet 15 and the second thermoplastic sheet 25 may be thermally deformable. The at least one first recess 20 and the at least one second recess 30 are aligned to create at least one fluid channel 40 through the continuous branched vascular network structure 35. In an example, the first thermoplastic sheet 15 may be an upper sheet and the second thermoplastic sheet 25 may be a lower sheet that are thermally welded together to form the at least one fluid channel 40 thereby creating an embedded vascular network (e.g., the continuous branched vascular network structure 35). The at least one fluid channel 40 may comprise any suitable size, shape, and/or configuration.

In an example, the thermoplastic vascular structure 10 is manufactured using a twin-sheet thermoforming method. The thermoplastic sheet thickness (i.e., thickness of the first thermoplastic sheet 15 and the second thermoplastic sheet 25) may be appropriately sized such that the thermoplastic vascular structure 10 meets all structural requirements as further defined below. The twin-sheet thermoforming method allows for single-step manufacturing of the at least one fluid channel 40 through thermoforming of the two separate thermoplastic sheets (e.g., the first thermoplastic sheet 15 and the second thermoplastic sheet 25), then welding the first thermoplastic sheet 15 and the second thermoplastic sheet 25 together using heat and high pressure contact between the two molded sheets 15, 25.

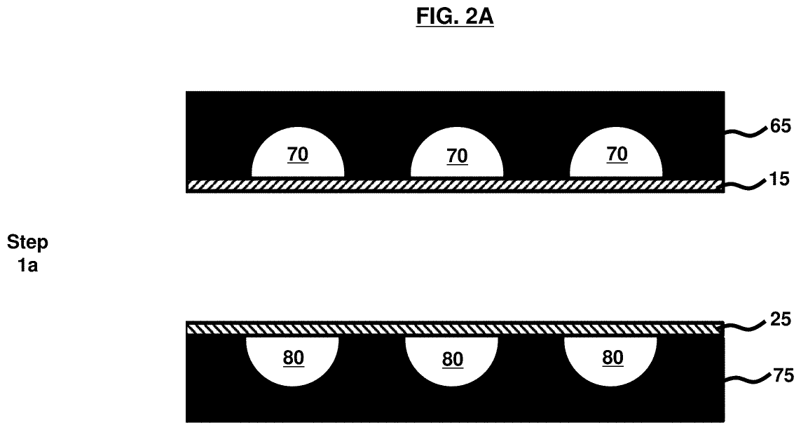

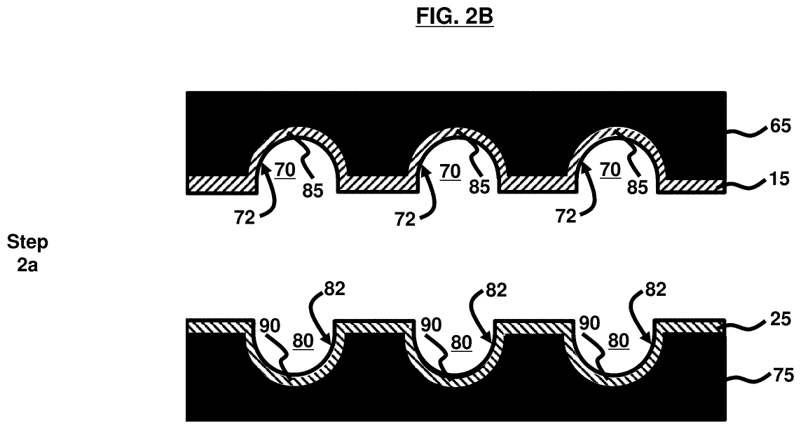

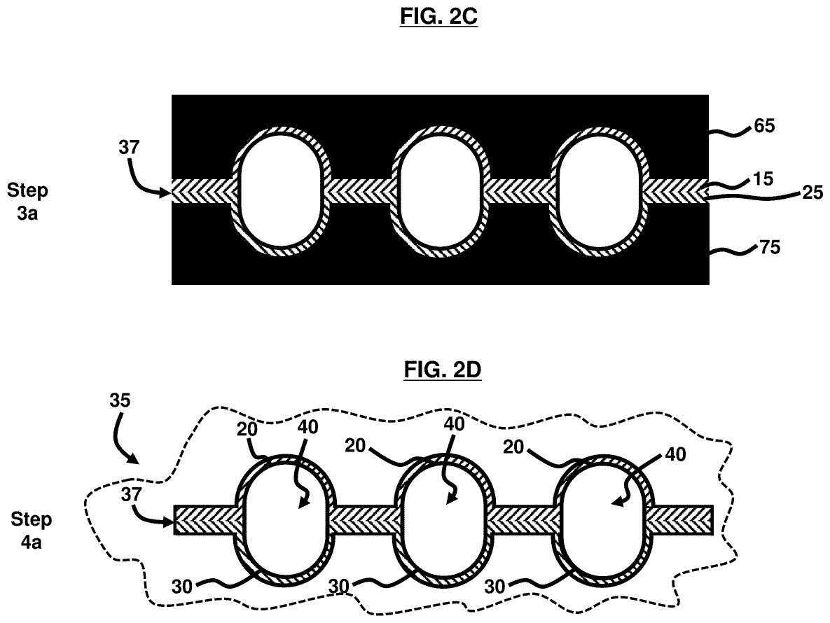

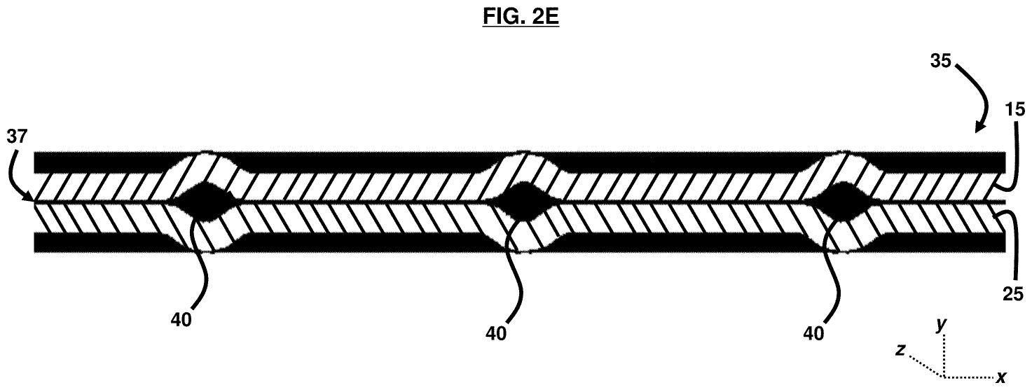

An example of the manufacturing process is shown in the schematic illustrations shown in the cross-sectional front views of FIGS. 2A through 2D, with reference to FIG. 1, where the upper and lower molds (e.g., the first structure-forming mold 65 and the second structure-forming mold 75, respectively) are positioned such that the upper and lower thermoplastic sheets (e.g., the first thermoplastic sheet 15 and the second thermoplastic sheet 25, respectively) are shaped/fit into the at least one first recessed portion 70 of the first structure-forming mold 65 and the at least one second recessed portion 80 of the second structure-forming mold 75, respectively, in Step 1 a (FIG. 2A). Accordingly, in Step 2a (FIG. 2B), a first designated portion 85 of the first thermoplastic sheet 15 contours to a shape 72 of the at least one first recessed portion 70 of the first structure-forming mold 65, and similarly, a second designated portion 90 of the second thermoplastic sheet 25 contours to a shape 82 of the at least one second recessed portion 80 of the second structure-forming mold 75. The respective shapes 72, 82 of the at least one first recessed portion 70 and the at least one second recessed portion 80 may comprise any suitable shape/configuration. Likewise, the first designated portion 85 and the second designated portion 90 can also comprise any suitable shape/configuration. However, the shape/configuration of the first designated portion 85 and the second designated portion 90 will match/contour the respective shape/configuration of the shapes 72, 82 of the at least one first recessed portion 70 and the at least one second recessed portion 80. The first thermoplastic sheet 15 and the second thermoplastic sheet 25 are heated until properly softened, which is material dependent, and then vacuum is drawn to form the proper vascular networks (e.g., the at least one fluid channel 40 shown in FIG. 1). The first structure-forming mold 65 and the second structure-forming mold 75 are pressed together while the first thermoplastic sheet 15 and the second thermoplastic sheet 25 are still hot in Step 3a (FIG. 2C) thus creating a continuous piece of thermoplastic material 37. Then, in Step 4a (FIG. 2D), the continuous branched vascular network structure 35 is removed once cooled and then selectively shaped in a desired configuration. FIG. 2E, with reference to FIGS. 1 through 2D, illustrates a perspective view schematic diagram illustrating an example shape/configuration of the continuous branched vascular network structure 35 containing at least one fluid channel 40. Other shapes/configurations are possible in accordance with the embodiments herein.

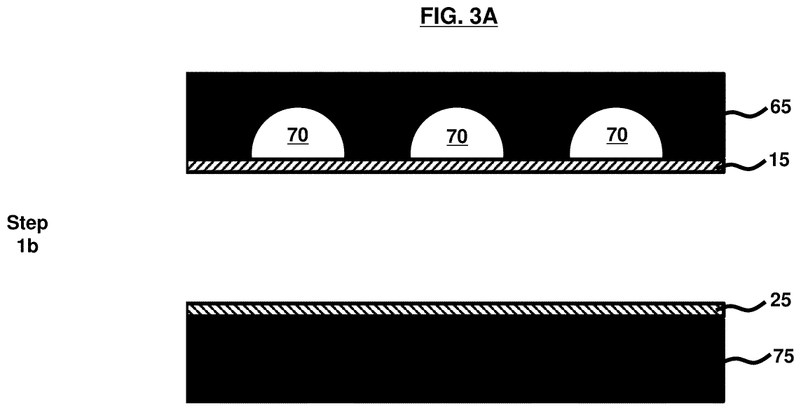

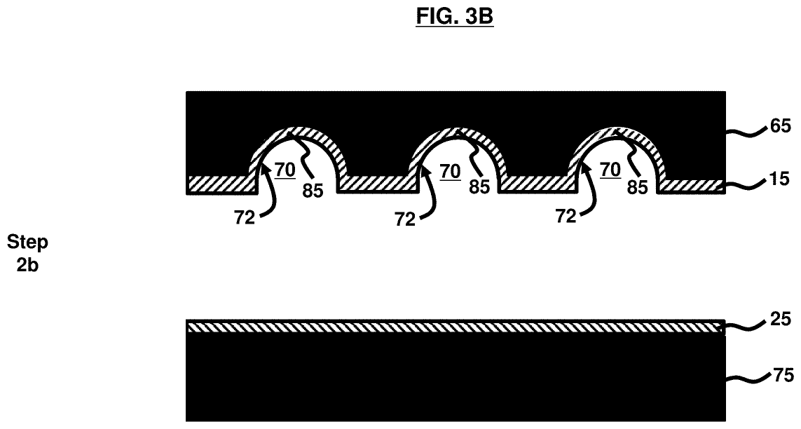

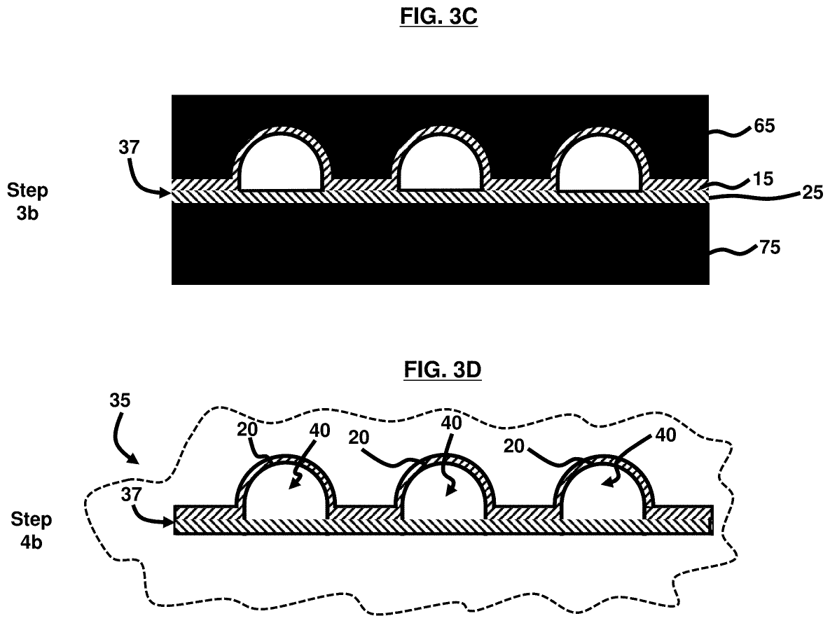

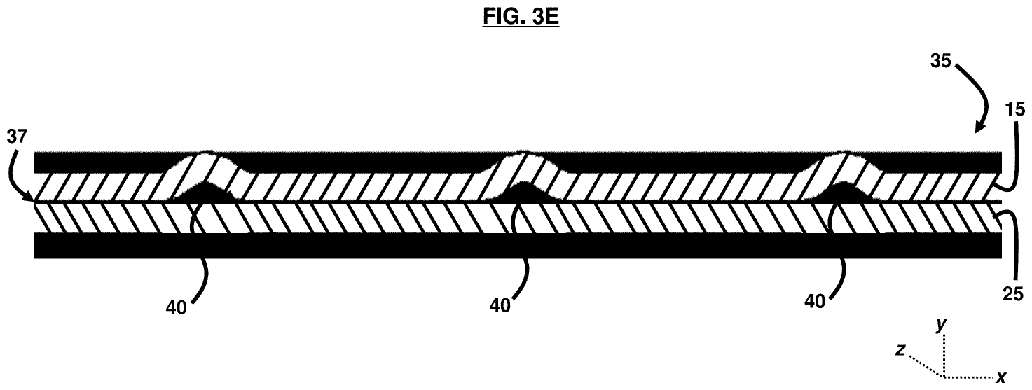

FIGS. 3A through 3D, with reference to FIGS. 1 through 2E, are cross-sectional front views illustrating steps for forming a thermoplastic vascular structure 10 comprising a first thermoplastic sheet 15 comprising at least one first recess 20. The thermoplastic vascular structure comprises a second thermoplastic sheet 25. The first thermoplastic sheet 15 is attached to the second thermoplastic sheet 25 to create a continuous branched vascular network structure 35 such that the first thermoplastic sheet 15 and the second thermoplastic sheet 25 form a continuous piece of thermoplastic material 37. The at least one first recess 20 creates at least one fluid channel 40 through the continuous branched vascular network structure 35. In Step 1b (FIG. 3A), the first thermoplastic sheet 15 and the second thermoplastic sheet 25 are provided on upper and lower molds (e.g., the first structure-forming mold 65 and the second structure-forming mold 75, respectively). The first structure-forming mold 65 comprises at least one first recessed portion 70. In step 2b (FIG. 3B), the first thermoplastic sheet 15 and the second thermoplastic sheet 25 are heated such that a first designated portion 85 of the first thermoplastic sheet 15 contours to a shape 72 of the at least one first recessed portion 70 of the first structure-forming mold 65, and vacuum is applied from behind both the first thermoplastic sheet 15 and the second thermoplastic sheet 25 to deform the sheets 15, 25. In step 3b (FIG. 3C), and interface between the first thermoplastic sheet 15 and the second thermoplastic sheet 25 is heated to a welding temperature of the materials/process until the two sheets 15, 25 are pressed together to form the weld, which creates the continuous piece of thermoplastic material 37. Then, in Step 4b (FIG. 3D), the continuous branched vascular network structure 35 may be removed once cooled and then selectively shaped in a desired configuration. FIG. 3E, with reference to FIGS. 1 through 3D, illustrates a perspective view schematic diagram illustrating an example shape/configuration of the continuous branched vascular network structure 35 containing at least one fluid channel 40. Other shapes/configurations are possible in accordance with the embodiments herein.

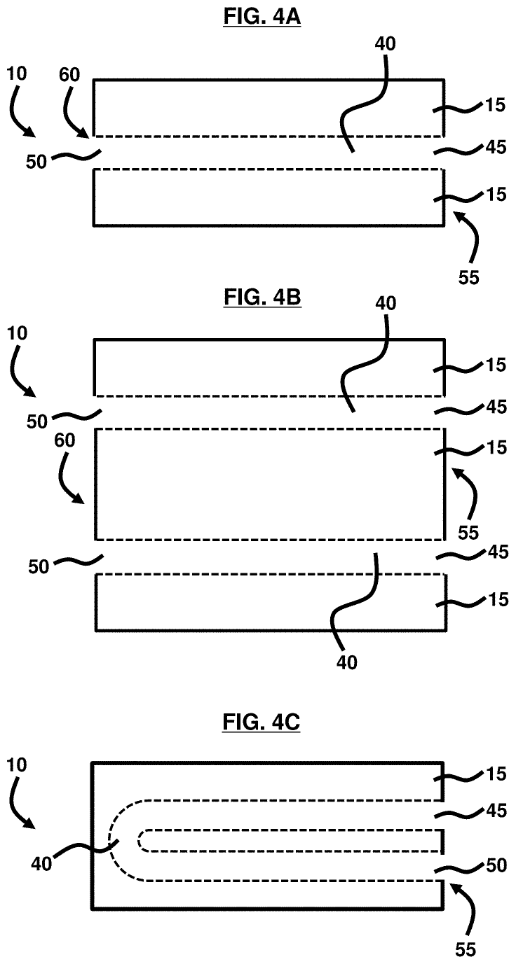

As shown in the top view schematic diagram of FIG. 4A, with reference to

FIGS. 1 through 3E, the thermoplastic vascular structure 10 may comprise at least one fluid inlet 45 connected to the at least one fluid channel 40, and at least one fluid outlet 50 connected to the at least one fluid channel 40. The at least one fluid inlet 45 and the at least one fluid outlet 50 may be configured as holes in the continuous branched vascular network structure 35 or may be configured as structural filters that are attached to the continuous branched vascular network structure 35, according to various examples. The at least one fluid inlet 45 and the at least one fluid outlet 50 that are connected to the at least one fluid channel 40 permit continuous fluid flow throughout the thermoplastic vascular structure 10. In another example, the at least one fluid inlet 45 and/or the at least one fluid outlet 50 may be selectively opened/closed to control the fluid flow through the thermoplastic vascular structure 10.

According to another example shown in the top view schematic diagram of FIG. 4B, with reference to FIGS. 1 through 4A, there may be a plurality of fluid channels 40, fluid inlets 45, and fluid outlets 50 suitably arranged on/in the continuous branched vascular network structure 35. The at least one fluid inlet 45 may be connected to the at least one fluid channel 40 at a first end 55 of the continuous branched vascular network structure 35, and the at least one fluid outlet 50 may be connected to the at least one fluid channel 40 at a second end 60 of the continuous branched vascular network structure 35 as shown in FIGS. 4A and 4B. Alternatively, as shown in the top view schematic diagram of FIG. 4C, with reference to FIGS. 1 through 4B, the at least one fluid outlet 50 may be connected to the at least one fluid channel 40 at the first end 55 of the continuous branched vascular network structure 35.

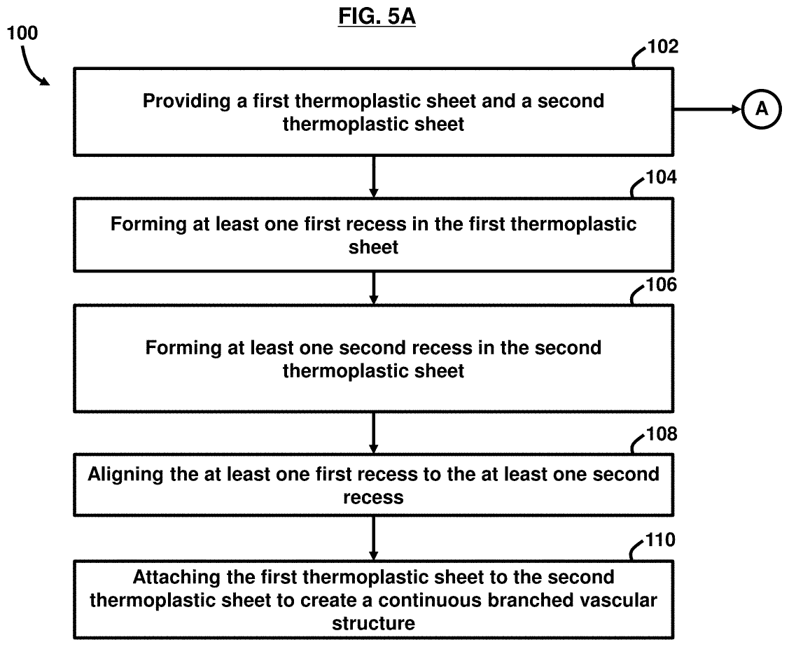

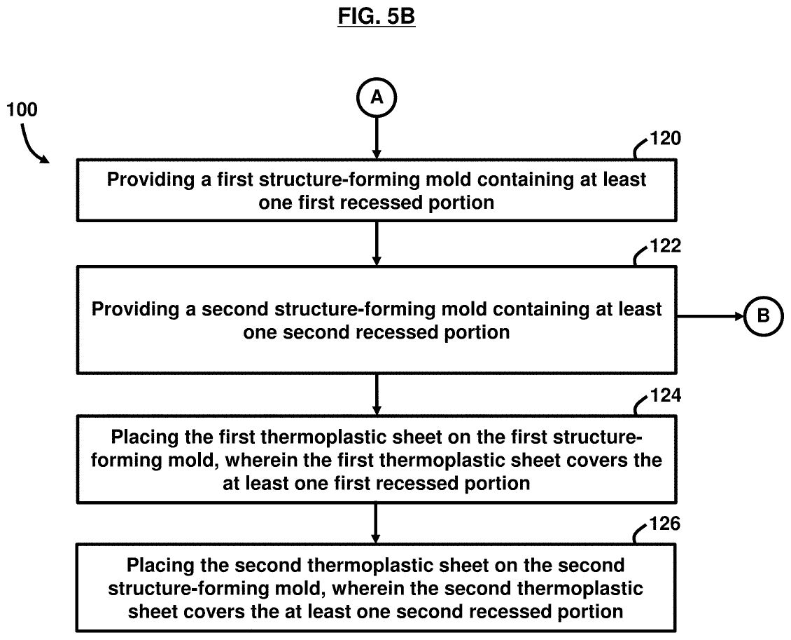

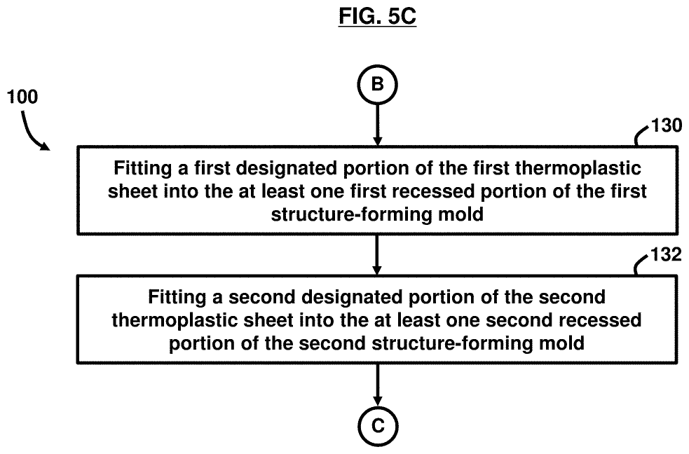

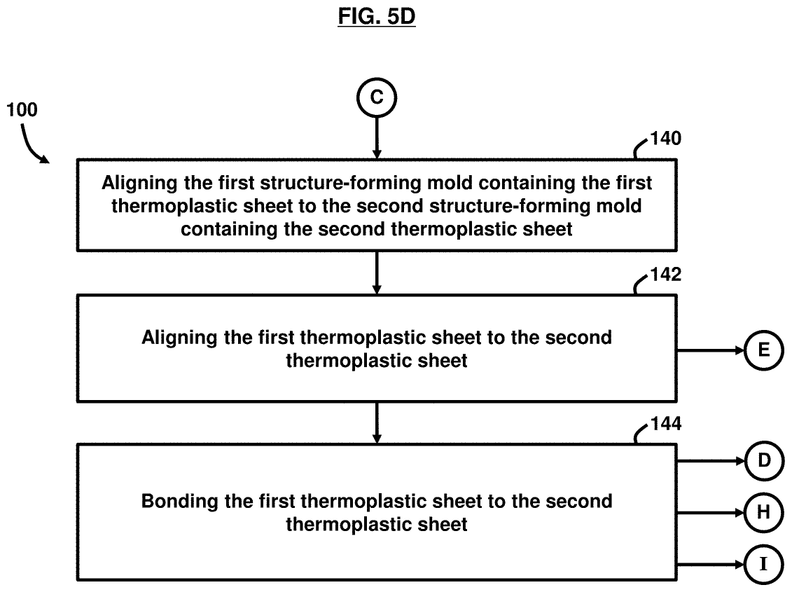

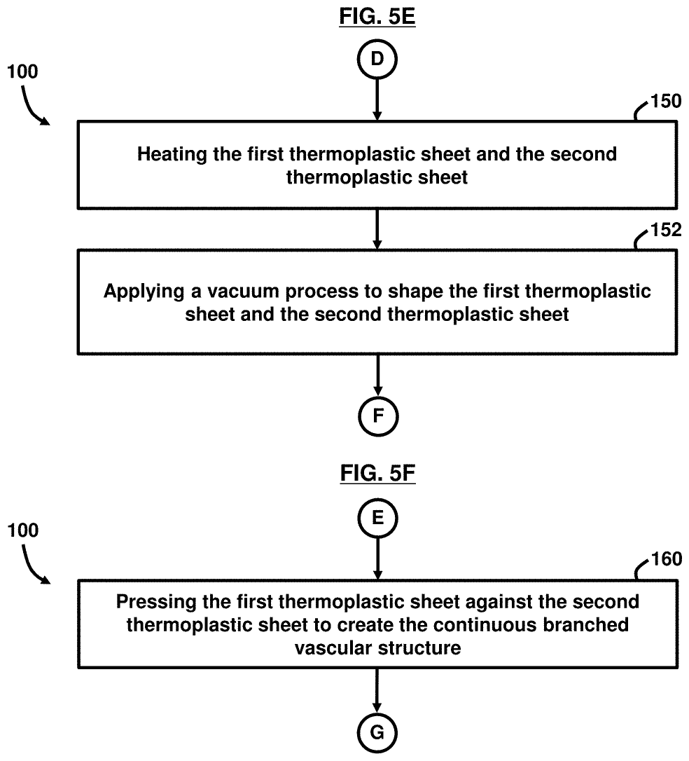

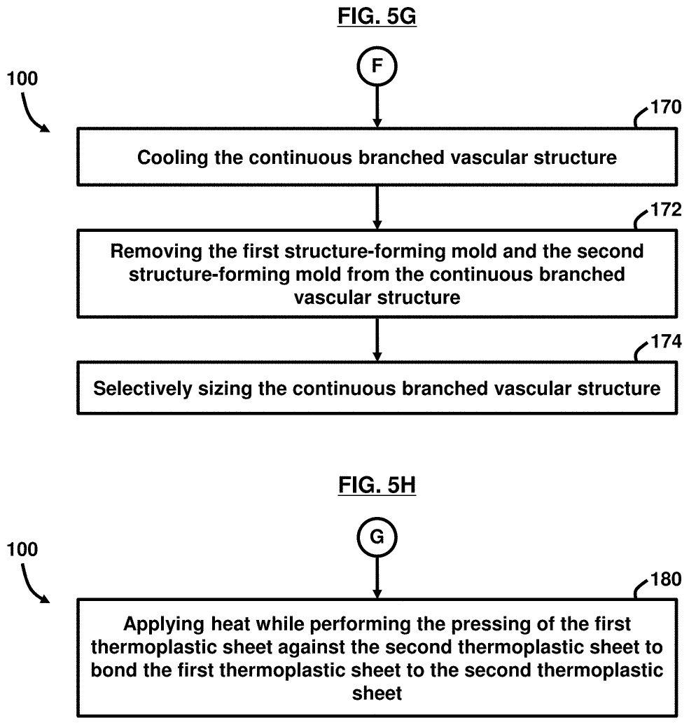

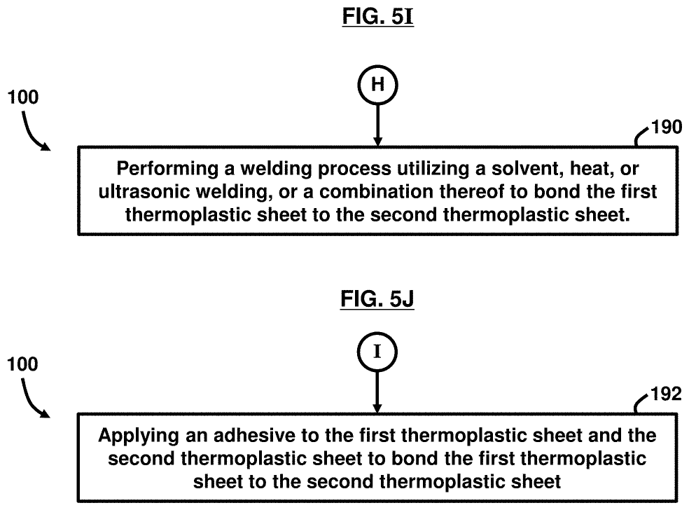

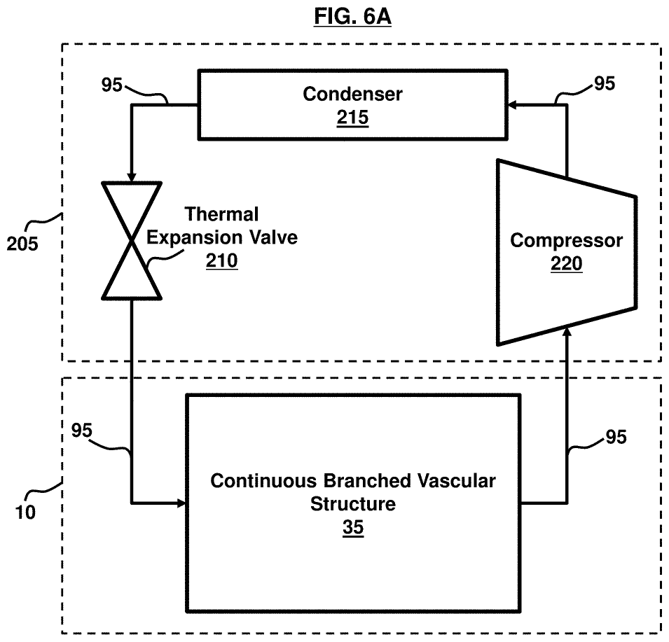

FIG. 5A through 5J, with reference to FIGS. 1 through 4C, are flow diagrams illustrating a method 100 of forming a thermoplastic vascular structure 10. As shown in FIG. 5A, the method 100 comprises providing (102) a first thermoplastic sheet 15 and a second thermoplastic sheet 25; forming (104) at least one first recess 20 in the first thermoplastic sheet 15; forming (106) at least one second recess 30 in the second thermoplastic sheet 25; aligning (108) the at least one first recess 20 to the at least one second recess 30; and attaching (110) the first thermoplastic sheet 15 to the second thermoplastic sheet 25 to create a continuous branched vascular network structure 35. The attachment of the first thermoplastic sheet 15 to the second thermoplastic sheet 25 with an alignment of the at least one first recess 20 to the at least one second recess 30 creates at least one fluid channel 40 through the continuous branched vascular network structure 35. The first thermoplastic sheet 15 and the second thermoplastic sheet 25 may each be appropriately sized to have any practical thickness. For example, the sheets 15, 25 may each have a thickness ranging from 0.005-0.75 inches, although the embodiments herein are not restricted to these particular thickness parameters.

As shown in FIG. 5B, the method 100 may comprise providing (120) a first structure-forming mold 65 containing at least one first recessed portion 70; providing (122) a second structure-forming mold 75 containing at least one second recessed portion 80; placing (124) the first thermoplastic sheet 15 on the first structure-forming mold 65, wherein the first thermoplastic sheet 15 covers the at least one first recessed portion 70; and placing (126) the second thermoplastic sheet 25 on the second structure-forming mold 75, wherein the second thermoplastic sheet 25 covers the at least one second recessed portion 80.

As shown in FIG. 5C, the method 100 may comprise fitting (130) a first designated portion 85 of the first thermoplastic sheet 15 into the at least one first recessed portion 70 of the first structure-forming mold 65 such that the first designated portion 85 of the first thermoplastic sheet 15 contours to a shape 72 of the at least one first recessed portion 70 of the first structure-forming mold 65 to create the at least one first recess 20 in the first thermoplastic sheet 15; and fitting (132) a second designated portion 90 of the second thermoplastic sheet 25 into the at least one second recessed portion 80 of the second structure-forming mold 75 such that the second designated portion 90 of the second thermoplastic sheet 25 contours to a shape 82 of the at least one second recessed portion 80 of the second structure-forming mold 75 to create the at least one second recess 30 in the second thermoplastic sheet 25.

As shown in FIG. 5D, the method 100 may comprise aligning (140) the first structure-forming mold 65 containing the first thermoplastic sheet 15 to the second structure-forming mold 75 containing the second thermoplastic sheet 25; aligning (142) the first thermoplastic sheet 15 to the second thermoplastic sheet 25 such that the at least one first recess 20 in the first thermoplastic sheet 15 aligns with the at least one second recess 30 in the second thermoplastic sheet 25; and bonding (144) the first thermoplastic sheet 15 to the second thermoplastic sheet 25. According to some examples, the temperature at which the first thermoplastic sheet 15 and the second thermoplastic sheet 25 bond to each other is dependent upon the type of material constituting the first thermoplastic sheet 15 and the second thermoplastic sheet 25, respectively. Moreover, the bonding temperature is also a process-related issue as well since some processes require a greater temperature relative to the melting point of the material than other processes require. For example, for PVC, the bonding temperature may be approximately 155-213° C. For LDPE, the bonding temperature may be approximately 108-121° C. For HDPE, the bonding temperature may be approximately 130-280° C. For PP, the bonding temperature may be approximately 177-249° C. For ABS, the bonding temperature may be approximately 149-323° C. The temperatures above represent the melting temperature ranges of some materials. The welding temperature is usually the minimum temperature needed to weld, and the process temperatures can range much higher.

As shown in FIG. 5E, the method 100 may comprise deforming the first thermoplastic sheet 15 and the second thermoplastic sheet 25 by a process comprising heating (150) the first thermoplastic sheet 15 and the second thermoplastic sheet 25; and applying (152) a vacuum process to shape the first thermoplastic sheet 15 and the second thermoplastic sheet 25. While several plastic manufacturing methods are capable of producing internal flow paths conducive to generating internal vascular fluid paths (e.g., at least one fluid channel 40), thermoforming is the most preferable in accordance with the embodiments herein. According to some examples, the temperature at which the first thermoplastic sheet 15 and the second thermoplastic sheet 25 deform is dependent upon the type of material constituting the first thermoplastic sheet 15 and the second thermoplastic sheet 25, respectively. For example, for PVC, the deformation temperature may be approximately 110-150° C. For LDPE, the deformation temperature may be approximately 125-175° C. For HDPE, the deformation temperature may be approximately 140-190° C. For PP, the deformation temperature may be approximately 140-165° C. For ABS, the deformation temperature may be approximately 160-190° C.

As shown in FIG. 5F, the method 100 may comprise pressing (160) the first thermoplastic sheet 15 against the second thermoplastic sheet 25 to create the continuous branched vascular network structure 35 comprising a continuous piece of thermoplastic material 37, wherein an alignment of the at least one first recess 20 with the at least one second recess 30 creates the at least one fluid channel 40. The pressing (160) process may occur at approximately 3-8 pounds per square inch (psi), although it may be more or less depending on the exact process and materials used. Using a thermoplastic material 37 to encapsulate the vascular fluid network (e.g., the at least one fluid channel 40) rather than a thermoset material allows the continuous branched vascular network structure 35 to be less expensive, rapidly manufactured, and less susceptible to damage by impact. This contrasts with the conventional solutions, which generally tend to be expensive and time consuming to manufacture, and relatively brittle with respect to commercially available thermoplastic materials. As shown in FIG. 5G, the method 100 may comprise cooling (170) (e.g., to room temperature, for example) the continuous branched vascular network structure 35; removing (172) the first structure-forming mold 65 and the second structure-forming mold 75 from the continuous branched vascular network structure 35; and selectively sizing (174) the continuous branched vascular network structure 35.

As shown in FIG. 5H, the method 100 may comprise applying (180) heat while performing the pressing of the first thermoplastic sheet 15 against the second thermoplastic sheet 25 to bond the first thermoplastic sheet 15 to the second thermoplastic sheet 25. Both sides of the thermoplastic vascular structure 10 could be formed and welded together in a single step using the twin-sheet thermoforming method 100 described above. Alternatively, two (or more) thermoformed sheets may be bonded together in a separate step using a welding method (e.g., solvent, thermal, ultrasonic, etc.) or by using a conventional adhesive applied to the bonding surfaces, as described below.

As shown in FIG. 5I, the bonding (144) of the first thermoplastic sheet 15 to the second thermoplastic sheet 25 may comprise performing (190) a welding process utilizing a solvent, heat, or ultrasonic welding, or a combination thereof to bond the first thermoplastic sheet 15 to the second thermoplastic sheet 25. Some examples of the type of solvent that may be used include Dichloromethane, Methyl Ethyl Ketone (MEK), Methyl Isobutyl Ketone, Methylene Chloride, Ethylene Dichloride (EDC), Vinyl Trichloride, Acetone, Toluene, Xylene, Cyclohexane, Tetrahydrofuran, Benzene, or Hexane. However, the embodiments herein are not restricted to these particular solvents, and accordingly other solvents may be utilized, as appropriate, such that the solvent choice is dependent on the material being used for the first thermoplastic sheet 15 and the second thermoplastic sheet 25.

As shown in FIG. 5J, the bonding (144) of the first thermoplastic sheet 15 to the second thermoplastic sheet 25 may comprise applying (192) an adhesive to the first thermoplastic sheet 15 and the second thermoplastic sheet 25 to bond the first thermoplastic sheet 15 to the second thermoplastic sheet 25. Some examples of the type of adhesive that may be used include Cyanoacrylate, Acrylic, Epoxy, or Polyurethane. However, the embodiments herein are not restricted to these particular adhesives, and accordingly other adhesives may be utilized, as appropriate, such that the adhesive choice is dependent on the material being used for the first thermoplastic sheet 15 and the second thermoplastic sheet 25. The bonding (144) techniques described above are not an exhaustive list of manufacturing methods, and other thermoplastic manufacturing methods may be technically feasible in producing small and intricate internal geometries required to form the continuous branched vascular network structure 35 in accordance with the embodiments herein.

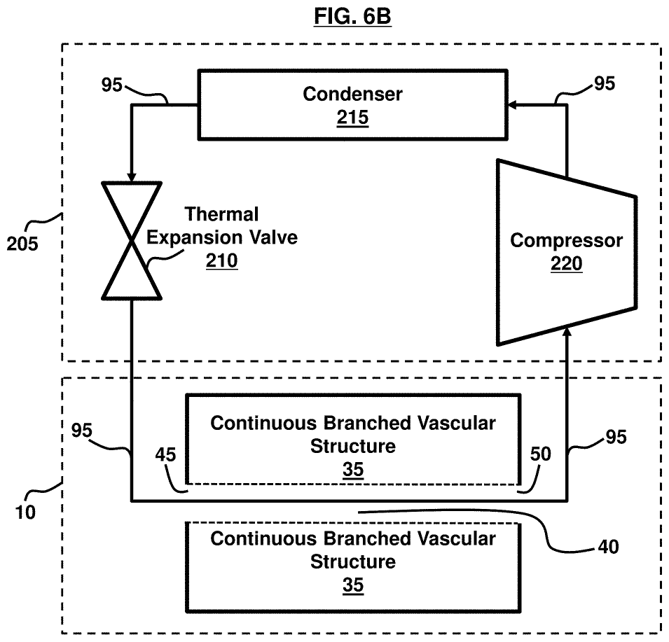

FIG. 6A, with reference to FIGS. 1A through 5J, is a block diagram illustrating a two-phase thermal control system 200 according to an example. The system 200 comprises a vapor-compression refrigeration cycle (VCRC) sub-system 205 comprising at least one thermal expansion valve 210, at least one condenser 215 operatively connected to the at least one thermal expansion valve 210, and at least one compressor 220 operatively connected to the at least one condenser 215, wherein the at least one compressor 220 provides mechanical work to the VCRC sub-system 205. The at least one condenser 215 may receive fluid 95 from the at least one compressor 220 and transmit the fluid 95 to the at least one thermal expansion valve 210.

The system 200 further comprises a thermoplastic vascular structure 10 operatively connected to the at least one thermal expansion valve 210 and the at least one compressor 220. The VCRC sub-system 205 is configured to provide the fluid 95 to the thermoplastic vascular structure 10. With reference to FIGS. 1 through 4C, the thermoplastic vascular structure 10 comprises a first thermoplastic sheet 15 comprising at least one first recess 20, and a second thermoplastic sheet 25. The first thermoplastic sheet 15 is attached to the second thermoplastic sheet 25 to create a continuous branched vascular network structure 35. The at least one first recess 20 creates at least one fluid channel 40 through the continuous branched vascular network structure 35. In the manufacturing process, once thermoforming is complete, the continuous branched vascular network structure 35 is trimmed to net-shape and operatively connected to the VCRC sub-system 205 as part of the two-phase thermal control system 200 to actively manage the temperature of the thermoplastic vascular structure 10.

As shown in FIG. 6B, with reference to FIGS. 1A through 6A, the thermoplastic vascular structure 10 may comprise at least one fluid inlet 45 connected to the at least one fluid channel 40, and at least one fluid outlet 50 connected to the at least one fluid channel 40. The at least one fluid inlet 45 is to receive fluid 95 from the at least one thermal expansion valve 210 of the VCRC sub-system 205. Moreover, the at least one fluid channel 40 of the continuous branched vascular network structure 35 is to receive the fluid 95 from the at least one fluid inlet 45 and permit heat transfer of the thermoplastic vascular structure 10 while the fluid 95 flows through the at least one fluid channel 40. Furthermore, the at least one fluid outlet 50 is to transmit the fluid 95 from the thermoplastic vascular structure 10 to the at least one compressor 220 of the VCRC sub-system 205. By flowing fluid 95 through the continuous branched vascular network structure 35, the surface temperature of the thermoplastic vascular structure 10 may be actively managed by the connected fluid system (e.g., VCRC sub-system 205). The thermoplastic vascular structure 10 may optionally be integrated into a two-phase thermal management system (not shown) for improved system capability and performance. Moreover, the thermoplastic vascular structure 10 may be configured such that it is capable of sustaining fluid temperatures and pressures as operating conditions dictate.

The thermoplastic vascular structure 10 may optionally be configured to operate using a two-phase working fluid. Accordingly, the fluid 95 comprises a two-phase working fluid, which operates under a condition where the pressure of the fluid 95 is a direct function of the temperature of the fluid 95. For the thermal control system 200 to perform at a prescribed operating condition, the thermoplastic vascular structure 10 containing the fluid 95 must be capable of sustaining the internal pressure generated by the fluid 95. For example, if the thermal control system 10 is configured to use R404a as the working fluid 95 and configured for operation at 40° C., then the thermoplastic vascular structure 10 must survive the fluid saturation pressure of 250 psig. To meet this, several parameters and material requirements must be maintained. The following structural requirements may also be valid for single-phase fluid systems but are typically far more critical for two-phase systems.

To contain the fluid pressure, the wall thickness and tensile strength of the first thermoplastic sheet 15 and the second thermoplastic sheet 25 should be dimensioned and configured to prevent burst due to excessive hoop stress for a given network channel diameter of the at least one fluid channel 40. Additionally, the two-phase system process may require vacuum to be drawn prior to filling, in which case the thermoplastic vascular structure 10 should be configured to prevent thin-walled buckling of the first thermoplastic sheet 15 and the second thermoplastic sheet 25 when vacuum is drawn on the continuous branched vascular network structure 35 to evacuate the structure 35 in the two-phase system filling process. Beyond simply sustaining the internal pressure of the working fluid 95, the thermoplastic vascular structure 10 should also be configured to prevent creep failure, which is a structural failure mechanism of thermoplastic materials in which the part fails slowly over a relatively long period of time in a relatively low stress state.

Moreover, the thermoplastic vascular structure 10 should be configured such that under the specific operating hoop stress and temperature, the thermoplastic material 37 does not strain to the point where failure occurs due to a strain-thinned wall, failing the hoop stress calculation mentioned above. Furthermore, the bond strength of the first thermoplastic sheet 15 and the second thermoplastic sheet 25 should be accounted for in the analysis to ensure the bond of the two sheets 15, 25 can sustain the internal pressure. Since the bond is at the midplane and therefore relatively wide with respect to the thickness of the thermoplastic sheets 15, 25, creep will be more critical in the first thermoplastic sheet 15 and the second thermoplastic sheet 25 than in the bondline. As a result, creep is neglected in the analysis of the bond. The bond may be analyzed using a conventional hoop stress analysis by approximating the bondline width as the sheet thickness. Additionally, the bond strength is dependent on method of bonding (144) (e.g., weld, adhesive bond, etc.) and bond quality, and should be verified through additional testing for accurate analysis of the bond strength.

All of the above parameters were experimentally analyzed (tensile strength, sheet thickness, bond strength, and creep resistance) and were material dependent, and accordingly the design process for developing the thermoplastic vascular structure 10 in accordance with the embodiments herein was highly iterative to yield an optimal product. In addition to making design iterations to improve the final thermoplastic vascular structure performance, material changes were incorporated to improve performance as well. Material additives such as chopped fiber can add strength and stiffness to the thermoplastic vascular structure 10, and additives such as hexagonal Boron Nitride (h-BN) can improve the thermal conductivity to reduce the surface thermal gradient.

There are some alternatives to the embodiments herein including to: (i) use conventional thermal management systems, or (ii) use two-phase vascular composite structures. For (i), conventional thermal management systems may add size and weight to the overall thermoplastic vascular structure 10 by only acting as thermal management and not as a structural member. For (ii), two-phase vascular composite structures act as both a structural member and as a part of a greater thermal management system, but may be expensive, labor-intensive to manufacture, and relatively brittle. The embodiments herein have a wide range of practical applications including cooling of a phased-array radar system, thermal stability of a spacecraft optical deck, cooling of high-power electronics, solar panel cooling to increase performance and useful life, and embedded cooling of electronics such as a printed circuit board (PCB), for example.

The foregoing description of the specific embodiments will so fully reveal the general nature of the embodiments herein that others may, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein may be practiced with modification within the spirit and scope of the appended claims.

What is claimed is:

1. A thermoplastic vascular structure comprising:
a first thermoplastic sheet comprising at least one first recess; and
a second thermoplastic sheet,
wherein the first thermoplastic sheet is attached to the second thermoplastic sheet to create a continuous branched vascular network structure, and
wherein the at least one first recess creates at least one fluid channel through the continuous branched vascular network structure.

2. The thermoplastic vascular structure of claim 1, comprising:
at least one fluid inlet connected to the at least one fluid channel; and
at least one fluid outlet connected to the at least one fluid channel.

3. The thermoplastic vascular structure of claim 2, wherein the at least one fluid inlet is connected to the at least one fluid channel at a first end of the continuous branched vascular network structure.

4. The thermoplastic vascular structure of claim 3, wherein the at least one fluid outlet is connected to the at least one fluid channel at a second end of the continuous branched vascular network structure.

5. The thermoplastic vascular structure of claim 3, wherein the at least one fluid outlet is connected to the at least one fluid channel at the first end of the continuous branched vascular network structure.

6. The thermoplastic vascular structure of claim 1, wherein the first thermoplastic sheet and the second thermoplastic sheet are thermally deformable.

7. The thermoplastic vascular structure of claim 1, wherein the second thermoplastic sheet comprises at least one second recess, and wherein the at least one first recess of the first thermoplastic sheet aligns with the at least one second recess of the second thermoplastic sheet to create the at least one fluid channel through the continuous branched vascular network structure.

8. A method of forming a thermoplastic vascular structure, the method comprising:
providing a first thermoplastic sheet and a second thermoplastic sheet;
forming at least one first recess in the first thermoplastic sheet;
forming at least one second recess in the second thermoplastic sheet;
aligning the at least one first recess to the at least one second recess; and
attaching the first thermoplastic sheet to the second thermoplastic sheet to create a continuous branched vascular network structure, wherein attachment of the first thermoplastic sheet to the second thermoplastic sheet with an alignment of the at least one first recess to the at least one second recess creates at least one fluid channel through the continuous branched vascular network structure.

9. The method of claim 8, comprising:
providing a first structure-forming mold containing at least one first recessed portion;
providing a second structure-forming mold containing at least one second recessed portion;
placing the first thermoplastic sheet on the first structure-forming mold, wherein the first thermoplastic sheet covers the at least one first recessed portion; and
placing the second thermoplastic sheet on the second structure-forming mold, wherein the second thermoplastic sheet covers the at least one second recessed portion.

10. The method of claim 9, comprising:
fitting a first designated portion of the first thermoplastic sheet into the at least one first recessed portion of the first structure-forming mold such that the first designated portion of the first thermoplastic sheet contours to a shape of the at least one first recessed portion of the first structure-forming mold to create the at least one first recess in the first thermoplastic sheet; and
fitting a second designated portion of the second thermoplastic sheet into the at least one second recessed portion of the second structure-forming mold such that the second designated portion of the second thermoplastic sheet contours to a shape of the at least one second recessed portion of the second structure-forming mold to create the at least one second recess in the second thermoplastic sheet.

11. The method of claim 10, comprising:
aligning the first structure-forming mold containing the first thermoplastic sheet to the second structure-forming mold containing the second thermoplastic sheet;
aligning the first thermoplastic sheet to the second thermoplastic sheet such that the at least one first recess in the first thermoplastic sheet aligns with the at least one second recess in the second thermoplastic sheet; and
bonding the first thermoplastic sheet to the second thermoplastic sheet.

12. The method of claim 11, comprising deforming the first thermoplastic sheet and the second thermoplastic sheet by a process comprising:
heating the first thermoplastic sheet and the second thermoplastic sheet; and
applying a vacuum process to shape the first thermoplastic sheet and the second thermoplastic sheet.

13. The method of claim 12, comprising pressing the first thermoplastic sheet against the second thermoplastic sheet to create the continuous branched vascular network structure comprising a continuous piece of thermoplastic material, wherein an alignment of the at least one first recess with the at least one second recess creates the at least one fluid channel.

14. The method of claim 13, comprising:
cooling the continuous branched vascular network structure;
removing the first structure-forming mold and the second structure-forming mold from the continuous branched vascular network structure; and
selectively sizing the continuous branched vascular network structure.

15. The method of claim 13, comprising applying heat while performing the pressing of the first thermoplastic sheet against the second thermoplastic sheet to bond the first thermoplastic sheet to the second thermoplastic sheet.

16. The method of claim 11, wherein the bonding of the first thermoplastic sheet to the second thermoplastic sheet comprises performing a welding process utilizing a solvent, heat, or ultrasonic welding, or a combination thereof to bond the first thermoplastic sheet to the second thermoplastic sheet.

17. The method of claim 11, wherein the bonding of the first thermoplastic sheet to the second thermoplastic sheet comprises applying an adhesive to the first thermoplastic sheet and the second thermoplastic sheet to bond the first thermoplastic sheet to the second thermoplastic sheet.

18. A thermal control system comprising:
a vapor-compression refrigeration cycle (VCRC) sub-system comprising:
at least one thermal expansion valve;
at least one condenser operatively connected to the at least one thermal expansion valve; and
at least one compressor operatively connected to the at least one condenser;
a thermoplastic vascular structure operatively connected to the at least one thermal expansion valve and the at least one compressor, wherein the thermoplastic vascular structure comprises:
a first thermoplastic sheet comprising at least one first recess; and
a second thermoplastic sheet,
wherein the first thermoplastic sheet is attached to the second thermoplastic sheet to create a continuous branched vascular network structure, and
wherein the at least one first recess creates at least one fluid channel through the continuous branched vascular network structure.

19. The thermal control system of claim 18, wherein the thermoplastic vascular structure comprises:
at least one fluid inlet connected to the at least one fluid channel; and
at least one fluid outlet connected to the at least one fluid channel,
wherein the at least one fluid inlet is to receive fluid from the at least one thermal expansion valve of the VCRC sub-system,
wherein the at least one fluid channel of the continuous branched vascular network structure is to receive the fluid from the at least one fluid inlet and permit heat transfer of the thermoplastic vascular structure while the fluid flows through the at least one fluid channel, and
wherein the at least one fluid outlet is to transmit the fluid from the thermoplastic vascular structure to the at least one compressor of the VCRC sub-system.

20. The thermal control system of claim 19, wherein the at least one condenser receives the fluid from the at least one compressor and transmits the fluid to the at least one thermal expansion valve.
